(19) United States
(12) Patent Application Publication
(10) Pub. No.: US 2009/0287509 A1
(43) Pub. Date: Nov. 19, 2009

(54) METHOD AND SYSTEM FOR AUTOMATING INSURANCE CLAIMS PROCESSING

(75) Inventors: Jayanta Basak, New Delhi (IN); Desmond Lim, Singapore (SG); Rashmi Singh, New Delhi (IN)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: International Business Machines Corporation, Armonk, NY (US)

(21) Appl. No.: 12/122,142

(22) Filed: May 16, 2008

(51) Int. Cl. G06Q 40/00

(52) U.S. Cl. 705/4

(57) ABSTRACT

Techniques for automating insurance claim processing are provided. The techniques include obtaining at least one rule from historical data, using the at least one rule to segment a dataset, wherein segmenting the dataset comprises using an iterative process involving a pattern classification technique, using the segmented dataset to determine if a claim can be automatically settled, and automatically settling a claim if it is determined that the claim can be automatically settled.

### RELATED APPLICATION

The contents of co-pending U.S. patent application Ser. No. 12/119,011, filed on May 12, 2008 and entitled “Method for automatic insurance claims processing,” is hereby incorporated by reference in entirety.

### FIELD OF THE INVENTION

The present invention generally relates to information technology, and, more particularly, to insurance claims processing.

### BACKGROUND OF THE INVENTION

In an automotive insurance sector, currently all claims are subject to inspection by a claim adjuster and the amount of indemnity paid is determined as part of the adjustment process. It is commonly believed that claims adjusters can reliably process around six claims per day and no more than twelve without there being a decline in the quality of the inspections process. As the volume of claims grows, so does the workload of the claim analysts and adjusters. This can be mitigated by hiring more claims staff, but as the size of the claims department grows, the overheads grow, making claims processing a more costly affair on a per claim basis as volume increases.

The purpose of re-engineering the claims process is to improve the efficiency of the claims process by eliminating the need to perform unnecessary actions such as, for example, having an insurance adjuster review a claim. This can be done, for example, by having software that models the claims that insurance company processes and determines claims that need not be subject to the complete claims process. This not only improves the efficiency of claims processing, but also improves the customer experience, because claims from customers that are not likely to need review by a claims adjuster can be fast-tracked. The challenge, however, is to model the claims with enough accuracy to ensure that the productivity benefit gained by eliminating adjudication for those claims significantly exceeds the costs of errors made in misidentifying claims.

Existing approaches, however, do not automatically process the historical data to extract the rules for fast-tracking the claims. Also, existing approaches do not include using a decision tree (that is modified based on historical data) to automatically process insurance claims. Existing approaches also do not, for example, learn from the unsupervised data (or unlabeled data), learn and automatically segment the historical claim data without any supervised information, and/or provide any capability of learning and partitioning from the historical database to automatically generate rules for claim processing.

### SUMMARY OF THE INVENTION

Principles of the present invention provide techniques for automating insurance claims processing. An exemplary method (which may be computer-implemented) for automating insurance claim processing, according to one aspect of the invention, can include steps of obtaining at least one rule from historical data, using the at least one rule to segment a dataset, wherein segmenting the dataset comprises using an iterative process involving a pattern classification technique, using the segmented dataset to determine if a claim can be automatically settled, and automatically settling a claim if it is determined that the claim can be automatically settled.

At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a relationship between dependent variables in a database, according to an embodiment of the present invention;

FIG. 2 is a diagram illustrating original process architecture, according to an embodiment of the present invention;

FIG. 3 is a diagram illustrating augmented process architecture, according to an embodiment of the present invention;

FIG. 4 is a diagram illustrating a histogram depicting the time taken to approve a claim, according to an embodiment of the present invention;

FIG. 5 is a diagram illustrating an exemplary approach, according to an embodiment of the present invention;

FIG. 6 is a flow diagram illustrating techniques for automating insurance claim processing, according to an embodiment of the present invention; and

FIG. 7 is a system diagram of an exemplary computer system on which at least one embodiment of the present invention can be implemented.

### DETAILED DESCRIPTION OF PREFERRED EMBODIMENTS

Principles of the present invention include automated rule learning to perform fast-tracking the claims (for example, where an adjuster and/or surveyor need be or need not be sent to a specific location). It is to be appreciated that the terms “fast-tracked” and “not-fast-tracked,” as used herein, are not limited to those precise embodiments, and that various other terminology may be used by one skilled in the art without departing from the scope or spirit of the invention. Also, principles of the invention include techniques for automating the insurance claims processing system in the automotive sector. One or more embodiments of the invention not only automate claims processing, but also aids the insurance experts to understand the underlying rules.

One or more embodiments of the present invention learn rules from the historical data, and can enrich its rule-base as and when more and more historical data is gathered. The techniques described herein may include a database that includes all previous claims and the corresponding payments. In the database, no information is stored about what was the original claim amount (by the claimant). The amount that has been paid to the claimant is stored. Therefore, there is no way of identifying certain claims which are wrongly claimed. Based on this historical data, one can automatically segment the dataset using an iterative process involving a decision tree, learning where the dataset is automatically partitioned to identify certain claims that can be electronically settled.

Such a technique also provides the capability of automatically learning (generating) the rules for processing claims without manual intervention, as well as provides a facility for the domain experts to verify their domain knowledge. The domain experts can also alter and/or fine-tune the rules if necessary.

One or more embodiments of the invention deal with completely unsupervised data. In an exemplary database described here, only the paid claim amount is stored, and there is no labeled information (that is, that a claim is accepted or rejected). Also, one or more embodiments of the invention do not code the past experiences, but rather these codes are automatically learned in the form of rules.

As described herein, principles of the present invention include building an analytical model for predicting which claims can be fast-tracked. In order to build such a model, one can make assumptions such as, for example, that a set of historical data with proper labels representing which claims could have been fast-tracked is available, and that there exists an underlying model that can represent the historical data. In other words, the historical data can be viewed as a set of random samples derived subject to the underlying model.

Model prototyping can include, for example, a set of labeled historical data, and a model that can be built from the labeled historical data. The built model should provide an acceptable accuracy to cater to an enterprise need, and the model can be interpreted in terms of rules that can be understood by the domain experts.

Additionally, principles of the invention include observing the correspondence between the rules extracted from the model developed by data analysis and the current knowledge of the claims experts. A decision tree can be obtained from the historical data. The decision tree is able to predict the claims that can be fast-tracked (without the need of an adjuster). In addition, the decision tree can also reveal the rules based on which a claim can be fast-tracked and the rules match with the knowledge of the domain experts.

One or more embodiments of the invention can include raw input variables. The raw variables can be, for example, transformed to processed variables to be fed into the analytical model. Exemplary raw input variables can include claim number (claim_no), claim feature number that denotes if a claim is for bodily injury and/or death and/or property damage and/or theft, etc. (clm_feature_no), the name of the person who applied for claim (claimant_name) and coverage. Raw input variables can also include, for example, the office from where the insurance policy has been issued (Pol_issue_office), the date of loss (Loss_date), the location of the loss (Loss_location), the location of the office where the claim will be settled (Settling_office), the date on which the loss was reported (Loss_reported_date), and the indemnity paid (Indem_paid). Additionally, raw input variables can include, for example, the date on which the indemnity has been paid (Date), the cause of the loss (Cause_loss_text), the start date of the insurance policy (Policy_start_date), the end date of the insurance policy (Policy_end_date), the name of the policy holder (Policy_holder), the name of the vehicle make (Veh_make_name) and the name of the vehicle model (Veh_mdl_name).

One or more embodiments of the present invention can also include data cleansing and claim attribute selection. Usually one claim has more than one entry in the database registering when the claim was made, the part payments and the final settlement. The entries are merged. The settlement date is considered to be the last date of claim settlement. The claim amount is considered to be the total amount paid to the claimant including all part payments. The claim date is considered to be the first date when the claim was made. In the claims database, the vehicle makes are entered as unstructured text, and these entries are substituted by structured text. The vehicle models are further replaced by the mean price of the vehicle models. In the claims database, there are entries where the policy starts after the loss reporting date. These entries are removed as outliers. Similarly, the entries for which the loss reporting date is after the policy end date are also removed.

Several entries in a database can include the actual date in the calendar year. These are usually replaced by the difference with respect to a reference frame. For example, a loss reporting date can be replaced by attributes such as how far the loss reporting date is from the policy start date, and how far the policy end date is from the loss reporting date. If any one of these two is negative, then the corresponding claim is considered to be invalid. In a claims database, there can be information about the settling office location in the form ‘structured text,’ whereas the loss location is ‘unstructured text.’ A new entry (binary variable) is considered to indicate if the loss location is nearest to the ‘settling office’ or not. A similar binary variable can be used to indicate whether the policy holder is the same person as the claimant.

Informative fields that can be considered in the analysis can include, for example, claim-feature-number, coverage, settling-office, risk, vehicle make, match or no match between claimant and policy holder, yes or no if the loss location is closest to the settling office, delay in reporting the loss, time difference between loss reporting date and policy start date, time difference between the policy end date and the loss reporting date, and price of the car.

Processed input variables can include, for example, the claim number (claim_no), the claim feature number that denotes if a claim is for bodily injury and/or death and/or property damage and/or theft, etc. (clm_feature_no), coverage, the office from where the insurance policy has been issued (pol_issue_office), the location of the loss (loss_location), and the location of the office where the claim will be settled (settling_office). Processed input variables can also include, for example, the indemnity paid (indem_paid), the date on which the indemnity has been paid (Date), the cause of the loss (cause_loss_text), the name of the vehicle make (Veh_make_name), the name of the vehicle model (Veh_mdl_name), a check to see if the claimant name is the same as the policy holder's name (claimant_name_policy_holder) and a check to see if the loss location is the same as the settling office (loss_loc_settlingoff).

Additionally, processed input variables can include, for example, the difference between the loss date and the reported loss date (loss_date_loss_reported), the difference between the reported loss date and the policy start date (loss_reported_policy_start_date), the difference between the reported loss date and the policy end date (loss_reported_policy_end_date), the difference between the date of the indemnity payment and the reported loss date (date_loss_reported_date) and the average price of the vehicle model adjusted with respect to depreciation (Mean_Price).

One or more embodiments of the invention include sample labeling. The claims can be labeled based on the type of loss. For example, if a loss is “Bodily Injury” or “Property Damage” or “Death,” then the claim cannot be fast-tracked. The claims can be labeled based on the delay in a claim settlement. If the difference between claim settlement date and the loss reporting date is large enough, then one can consider that the claim cannot be potentially fast-tracked. As such, depending on the settling period, one can label the claims as ‘fast-track’-able or not. The optimal settlement time beyond which a claim can be considered as not ‘fast-track’-able can be, for example, 13-15 days. However, this can be a gross estimate taking all settling-offices into account. A settling-office-specific analysis can improve the results significantly. One can also consider the indemnity amount paid to be a significant variable for labeling. For example, such an amount can be a specified indemnity risk amount defined by the insurance organization.

The claims can also be labeled based on the indemnity paid in claim settlement. If the indemnity paid is large enough, then one can consider that the claim cannot be potentially fast-tracked. As such, depending on the indemnity paid, one can label the claims as ‘fast-track’-able or not. In this case, for example, one can consider the settlement time to be a significant variable for labeling, and fix its value to 14 days. As such, all of the claims for which the settlement time is greater than 14 days are considered as not fast track claims.

The claims in the database can contain all of the information regarding the claimant. The information about how much time is required to process the claim and what is the indemnity amount (the claim amount paid to the claimant) can also be available. However, in all cases available in the database, an adjuster and/or surveyor can be physically sent to the concerned location. In order to perform fast-tracking of the claims, either the unsupervised data has to be processed directly or certain judicious labeling needs to be imposed on the processed claims in the database so that supervised learning mechanism can be applied. The domain experts in such an instance are not able to specify which claims could have been fast-tracked and not-fast-tracked.

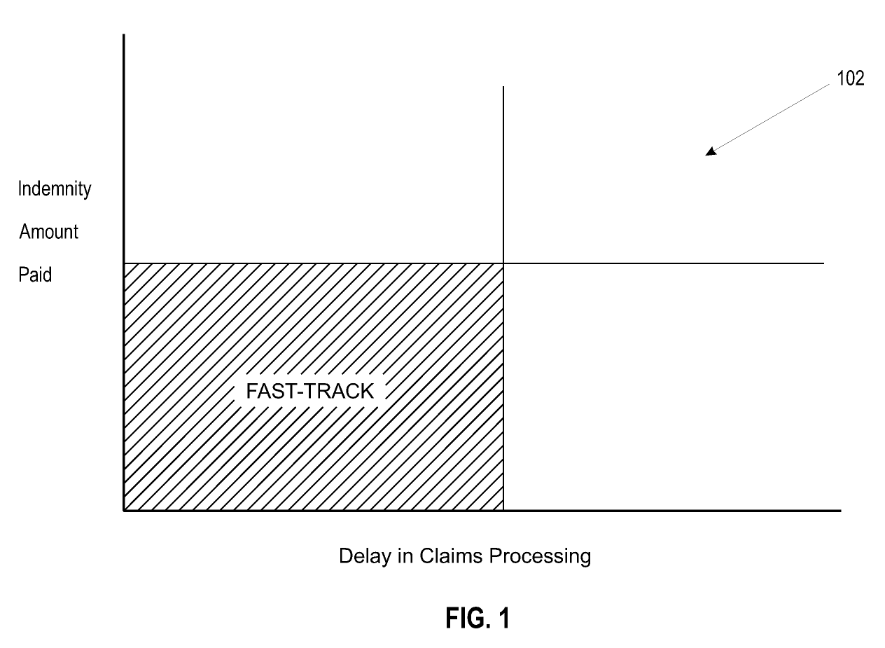

FIG. 1 is a diagram illustrating a relationship 102 between dependent variables in a database, according to an embodiment of the present invention. By way of illustration, FIG. 1 depicts the relationship between the dependent variables of “indemnity amount paid” and “delay in claims processing” with respect to determining whether or not a claim is to be fast-tracked.

In a database, there can be two dependant variables such as the claim amount paid, and the delay in processing the claim. Also, certain thresholds can exist on both these dependant variables such that if the claim amount is greater than a certain threshold, then the claims can be labeled as not-fast-tracked, and if the delay in processing is greater than a certain threshold, then the claims can be labeled as not-fast-tracked.

As such, a task exists in obtaining suitable thresholds on the dependant variables (which are observable). There are numerous techniques known by one skilled in the art for obtaining such thresholds from the histogram. However, such techniques are not applicable in one or more embodiments of the present invention for reasons such as described below. The histogram is totally uni-modal (that is, having a single mode in the distribution) in nature, and it follows a Poisson distribution. Therefore, there is no natural threshold that separates the behavior between ‘fast-track’ and ‘not-fast-track’ claims. The existing threshold selection techniques are guided by certain objective measures in the unsupervised domain. No such measure can be derived in the techniques described herein, and it is tied to the enterprise objectives. Additionally, the two observable variables of “delay” and “indemnity amount” are dependent on each other and cannot be treated independently.

Therefore, one or more embodiments of the invention use a strategy for labeling the samples analogous to the expectation-maximization algorithm such that one can fix a threshold for the indemnity amount, and decide a threshold for the delay. Also, one can fix the threshold for delay as obtained, and then decide a threshold for the indemnity amount. Additionally, one can repeat the above two steps until there is no significant change in both these thresholds. A question remains about how to decide a threshold for one dependent variable (for example, “delay”) with a given threshold for the other dependent variable (for example, “indemnity amount”). Deciding a threshold here can be tied to the enterprise decision.

One or more embodiments of the invention can consider only one dependent variable (for example, “delay”). Assume that a set of samples are actually ‘fast-track’ and the rest of the samples are ‘not-fast-track.’ In this case, if one were to choose a threshold=0, then all fast-track samples will be mis-classified by any learning machine. In other words, the false negative rate will be 100%. On the other hand, if the threshold is very high then all “not-fast-track” samples will be mis-classified by any learning machine and the false positive rate will be 100%. In both cases, there is an enterprise penalty in the sense that for a false negative sample, an adjuster cost has to be borne, and for a false positive case, a certain exaggerated amount may have to be paid. Therefore, a suitable threshold is that for which there is a balance between the weighted losses. That is, adjuster cost * false negative rate=average extra cost * false positive rate. As such, one can choose a threshold and then use a supervised machine learning tool (specifically, a decision tree in this context), and observe the false positive and false negative rates.

With equal weights on average adjuster cost and the cost wrong judgment, one can consider that threshold for which false positive rate and false negative rates are most closely matched. Note that these two rates may not be exactly equal, but can be closely matched because one is allowed to change the threshold only in discrete steps (for example, by one day and not by any fraction of a day). One can use, for example, the same technique for deciding the threshold on indemnity amount paid as described above. As described herein, the two thresholds can be iteratively refined until there is no significant change in the two threshold values. Once the threshold values converge, one can obtain the actual trained tool (for example, the trained decision tree), and with the trained decision tree one is able to decode the actual rules for which a claim can be “fast-tracked” or “not-fast-tracked.”

As described herein, one or more embodiments of the present invention include decision making (that is, rule generation). One or more embodiments of the invention use a machine learning model such as, for example, “DECISION TREE” for modeling the claims processing from the labeled historical claims data. A decision tree handles the categorical (non-numeric) variables as elegantly as the numeric ones, and at the same time, decision trees are data-driven and no assumption is made about the underlying parametric models. Further, decision trees can be easily interpreted in terms of enterprise rules.

A decision tree is a tree where each leaf node represents a particular decision. For example, the decision can be whether an item is either fast-track or not-fast-track. Each intermediate (non-leaf) node represents a particular condition based on the claim field attribute. Different claim fields are tested at different intermediate nodes. Every claim is tested from the very root node and a particular path is followed from the root node to one of the leaf nodes determined by the values of the claim field attributes. Therefore, each leaf node can be interpreted as a composite rule conjunctively composed of the clauses governed by the intermediate nodes on the path from the root node to that leaf node.

A decision tree can be constructed by recursively partitioning the available dataset at each intermediate node such that the mixture of different labels (for example, fast-track and not-fast-track) in the data is minimized in the resulting child nodes. Because there is no numeric computation on the attribute values explicitly in each intermediate node, a decision tree can elegantly handle a mixture of numeric and categorical variables.

It is possible to label the historical data available in the claims database based on several factors such as, for example, the time taken in the claim settlement, and the claim amount actually paid to the claimant. A preliminary predictive model can provide, for example, 62% accuracy in predicting the fast-tracked claims. Accuracy improves, for example, when location-specific models are built. There can be different types of errors incurred. For example, there can be an error in predicting a claim as fast-tracked where it 1S is actually not-fast-tracked. This is an unsafe error from the enterprise risk point view. Also, there can be an error in predicting a claim as not-fast-track where it could be fast-tracked. This is a safe error from the enterprise risk point of view although an extra cost is involved due to the adjuster.

Accuracy can be achieved, for example, by the preliminary predictive model when the safe error is equal to the unsafe error. The unsafe error can be reduced at the cost of safe error and vice-versa. One can improve accuracy by including more predictive variables (that is, claims data fields) and using more sophisticated models. The model can be interpreted in terms of rules governed by the claims data fields.

As an example, a decision tree model built on labeled data is able to extract certain rules that are actually verified by the domain experts of the insurance company as follows. Assume that a hypothesis states that claims made of rollover policies early in their lifetime are more likely to be exaggerated. As such, for determining the finding or decision tree, if the gap between the loss-reporting-date and the policy-start-date is less than a certain threshold, then it is always flagged as “not-fast-track,” and the threshold is decided automatically by the decision tree.

Additionally, assume that a hypothesis states that claims made in a city geographically distant from the actual loss location are likely to be exaggerated. As such, for determining the finding or decision tree, if the loss-location is not closest to the settling office, then it follows a path in the tree that is more likely to be “not-fast-track.” Assume that a hypothesis states that claims not made by the policy holder, but rather by non-approved garages, are more likely to be exaggerated. As such, for determining the finding or decision tree, if the claimant name is not the same as the policy holder's name, then the claim is most likely to be “not-fast-track.”

Further, assume a hypothesis states t hat some descriptions of the reported damage are more likely to be exaggerated than others. As such, for determining the finding or decision tree, the cause-loss-text, which is a structured text in the claims database, plays an important role in making a decision about “fast-track” or “not-fast-track.”

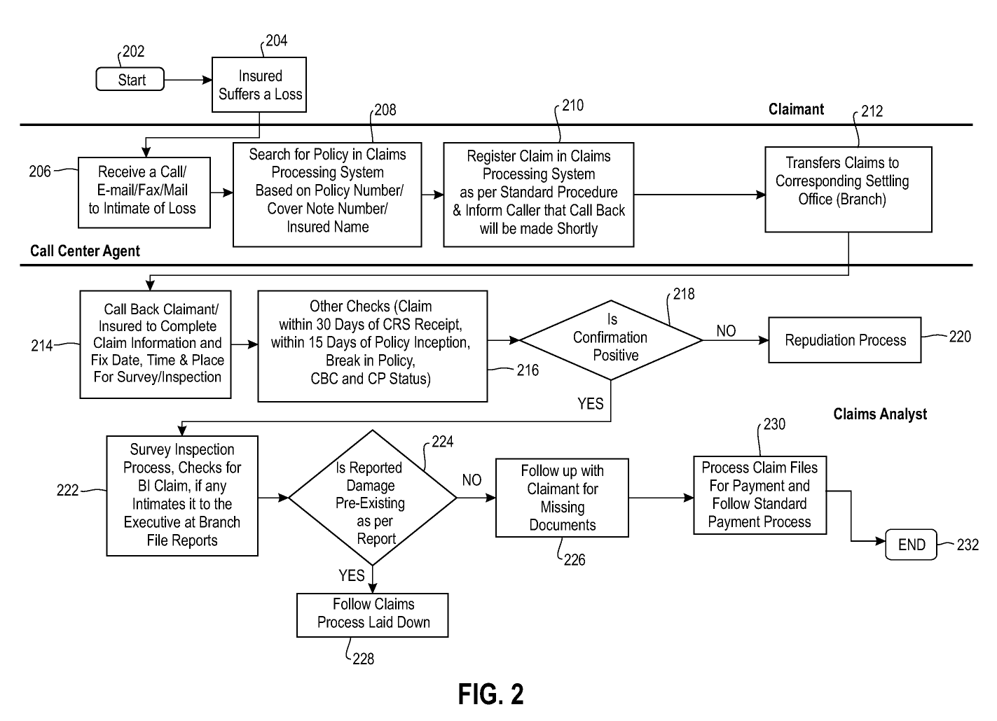

FIG. 2 is a diagram illustrating original process architecture, according to an embodiment of the present invention. By way of illustration, FIG. 2 depicts actions by a claimant, actions by a call center agent and actions by a claims analyst. Actions by a claimant can include starting a process in step 202, and the insured suffering a loss in step 204. Actions by a call center agent can include receiving a call and/or e-mail and/or fax and/or mail to intimate the loss in step 206, searching for the policy in a claim processing system based on a policy number and/or cover note number and/or insured name in step 208. Actions by a call center agent can also include registering the claim in a claims processing system as per standard procedure, and informing the caller that a call back will be made shortly in step 210, as well as transferring claims to a corresponding settling office or branch in step 212.

Actions by a claims analyst can include calling back the claimant and/or insured to complete claim information and fix the date, time and place for a survey and/or inspection in step 214, and making other checks in step 216 (for example, claim within 30 days of the claims report submitted (CRS) receipt, within 15 days of policy inception, break in policy, call back claimant (CBC) and claims processing (CP) status, etc.). By way of example, one can check to determine that the CRS has been formally executed, and also formally verify that the claimant has submitted the claim with a call back to the claimant (CBC) and specifics of the claims report are correct as submitted and that the CP status on the system is still open before issuing the payment and closure. A claims analyst can also determine whether a confirmation is positive in step 218. If the answer is no, a repudiation process can take place in step 220. If the answer is yes, a survey inspection process and checks for a bodily injury (BI) claim can be performed in step 222 if any intimates it to the executive at a branch file reports.

Further, a claims analyst can determine whether the reported damage is pre-existing as per the report in claim 224. If the answer is yes, the claims analyst follows the claims process laid down in step 228. If the answer is no, the claims analyst can follow up with the claimant for missing documents in step 226. Additionally, a claims analyst can process claim files for payment and follow standard payment process in step 230, as well as end the process in step 232.

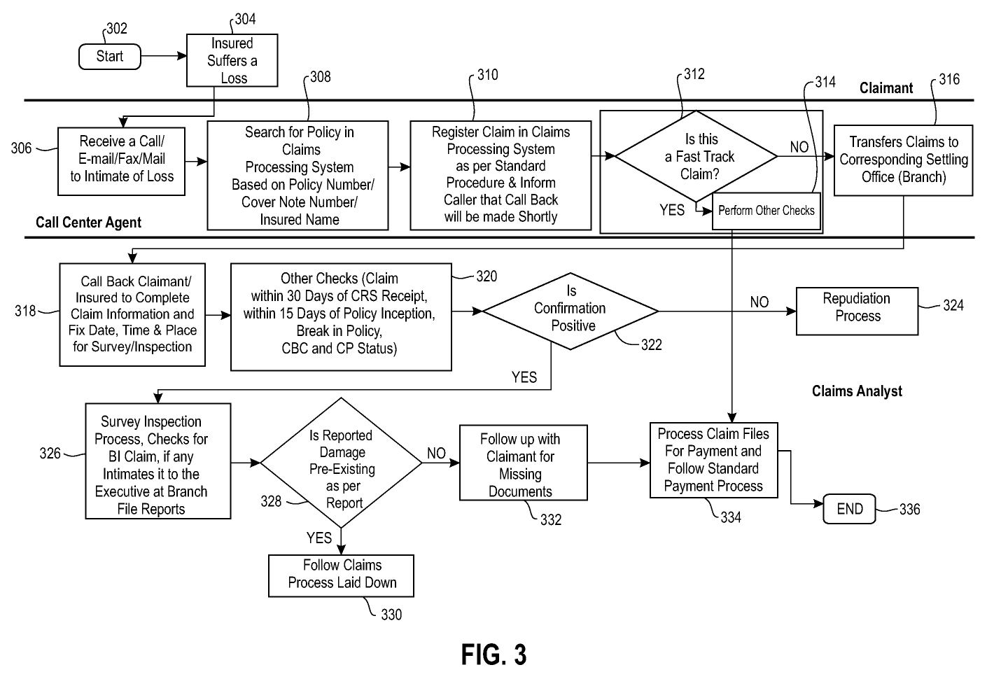

FIG. 3 is a diagram illustrating augmented process architecture, according to an embodiment of the present invention. By way of illustration, FIG. 3 depicts actions by a claimant, actions by a call center agent and actions by a claims analyst. Actions by a claimant can include starting a process in step 302, and the insured suffering a loss in step 304. Actions by a call center agent can include receiving a call and/or e-mail and/or fax and/or mail to intimate the loss in step 306, searching for the policy in a claim processing system based on a policy number and/or cover note number and/or insured name in step 308. Actions by a call center agent can also include registering the claim in a claims processing system as per standard procedure, and informing the caller that a call back will be made shortly in step 310.

Further, a call center agent can determine whether the present claim is a fast track claim or not in step 312. If the answer is yes, the call center agent performs other checks in step 314. If the answer is no, then the call center agent can also transfer claims to a corresponding settling office or branch in step 316.

Actions by a claims analyst can include calling back the claimant and/or insured to complete claim information and fix the date, time and place for a survey and/or inspection in step 318, and making other checks in step 320 (for example, claim within 30 days of CRS receipt, within 15 days of policy inception, break in policy, CBC and CP status, etc.). A claims analyst can also determine whether a confirmation is positive in step 322. If the answer is no, a repudiation process can take place in step 324. If the answer is yes, a survey inspection process and checks for BI claim can be performed in step 326 if any intimates it to the executive at a branch file reports.

Further, a claims analyst can determine whether the reported damage is pre-existing as per the report in claim 328. If the answer is yes, the claims analyst follows the claims process laid down in step 330. If the answer is no, the claims analyst can follow up with the claimant for missing documents in step 332. Additionally, a claims analyst can process claim files for payment and follow standard payment process in step 334, as well as end the process in step 336.

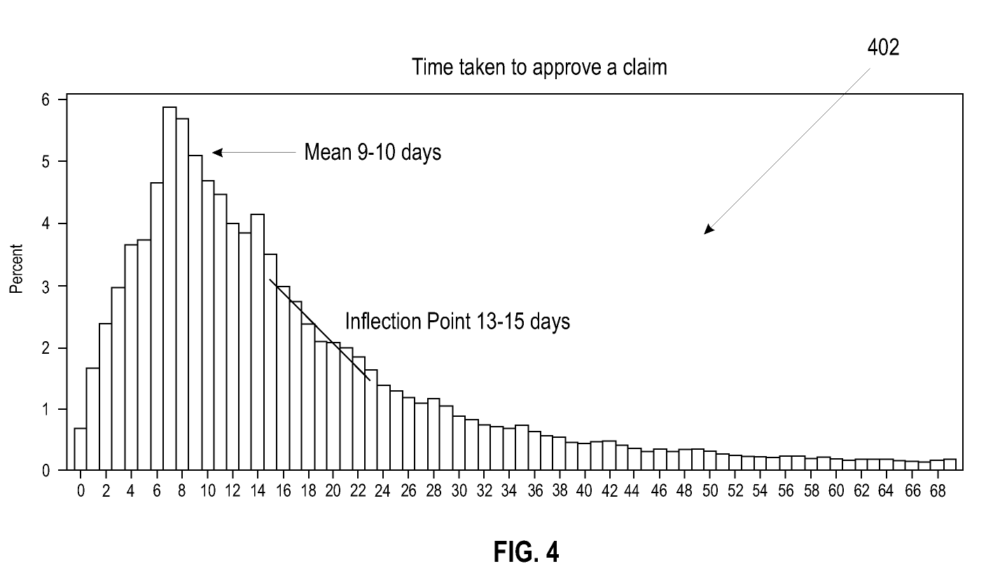

FIG. 4 is a diagram illustrating a histogram 402 depicting the time taken to approve a claim, according to an embodiment of the present invention. In one or more embodiments of the invention, one can, on the same line illustrated in FIG. 4, plot histogram for indemnity paid keeping settlement time fixed to 14 days.

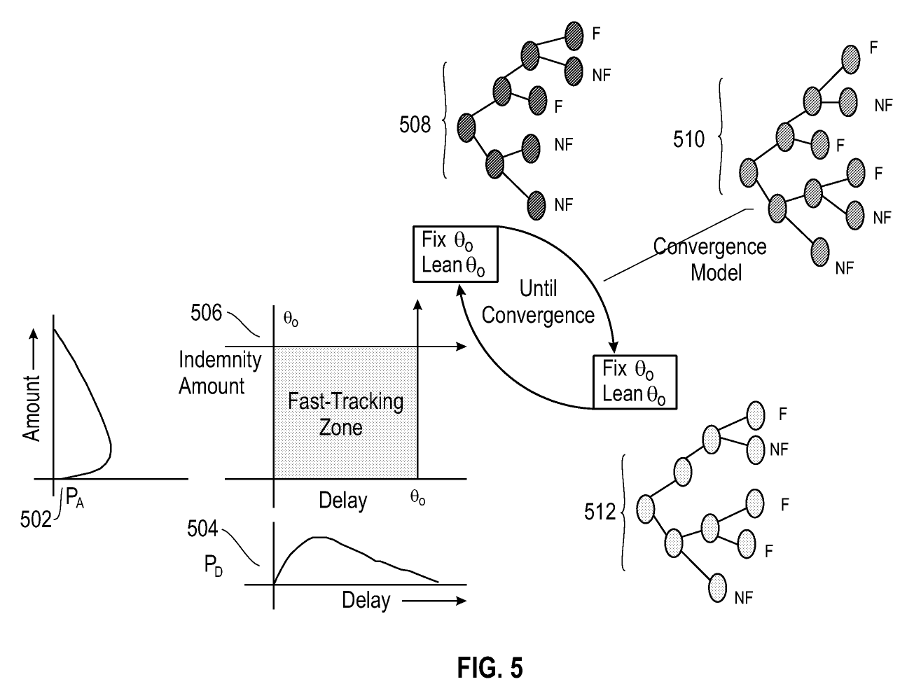

FIG. 5 is a diagram illustrating an exemplary approach, according to an embodiment of the present invention. By way of illustration, FIG. 5 depicts the elements of distribution of the indemnity amount in the historical data (represented as a histogram) 502, distribution of the delay 504, a relationship between dependent variables in a database 506, a decision tree 508 constructed by fixing theta_c (a threshold over the indemnity amount paid) and obtaining the optimal delay threshold theta-D to make a balance between the false positive and false negative, a unique decision tree 510 and a decision tree 512 constructed by fixing theta-D (a threshold over delay) and obtaining the optimal amount threshold theta-C to make a balance between the false positive and false negative.

The theta-D obtained from 508 is fed to 512, and then the theta-C obtained from 512 is fed to 508. The process is repeated until they do not change any more (convergence). Once the process converges, one can obtain a unique decision tree (not two different trees) as in 510.

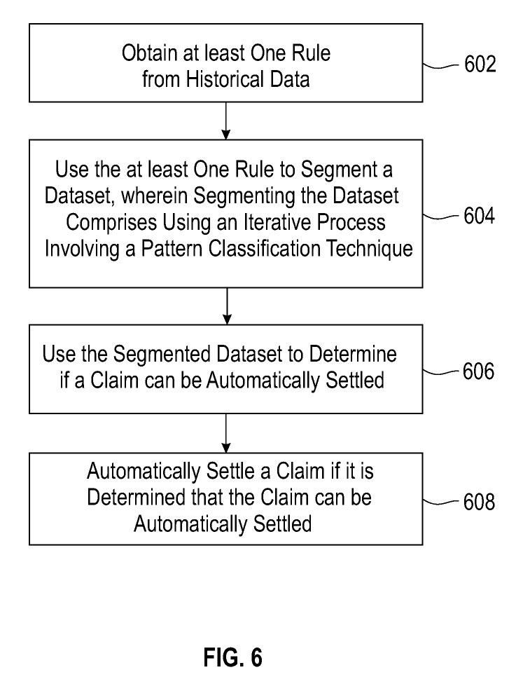

FIG. 6 is a flow diagram illustrating techniques for automating insurance claim processing, according to an embodiment of the present invention. Step 602 includes obtaining rules from historical data. The historical data can include, for example, a set of samples derived subject to an underlying claim processing model. Step 604 includes using the rules to segment a dataset, wherein segmenting the dataset includes using an iterative process involving a pattern classification technique (for example, a decision IS tree). Step 606 includes using the segmented dataset to determine if a claim can be automatically settled. Step 608 includes automatically settling a claim if it is determined that the claim can be automatically settled.

The techniques depicted in FIG. 6 can also include enriching the historical data as additional data is gathered, manually changing one of the rules, and observing a correspondence between the rules from the historical data and current knowledge of one or more claims experts. Additionally, one or more embodiments of the invention can include labeling a claim based on at least one variable (for example, type of loss, delay in a claim settlement and an indemnity paid in claim settlement). Also, one can apply a threshold to each variable, wherein the threshold corresponds to determining whether the claim can be automatically settled.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

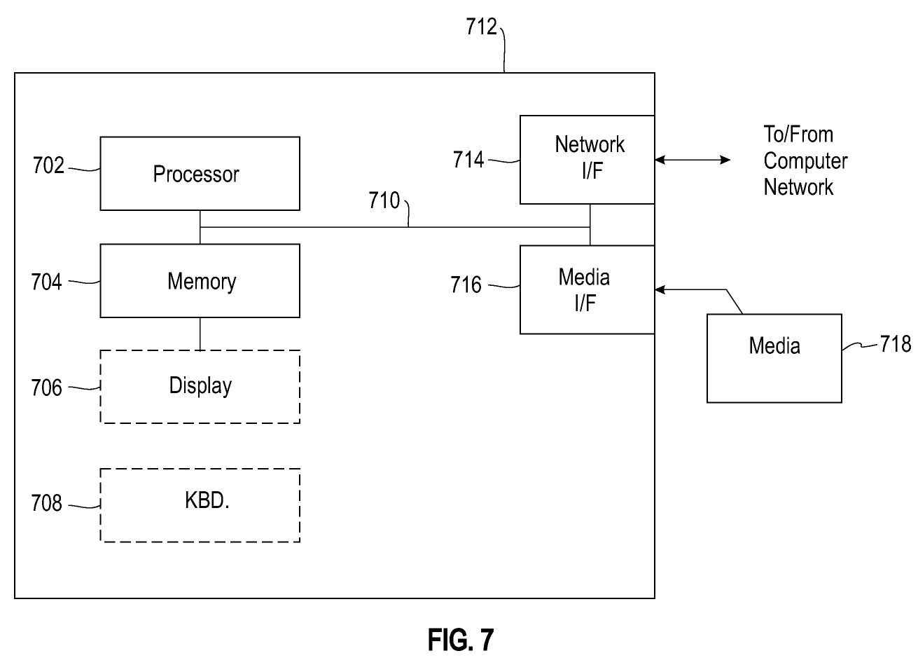

At present, it is believed that the preferred implementation will make substantial use of software running on a general-purpose computer or workstation. With reference to FIG. 7, such an implementation might employ, for example, a processor 702, a memory 704, and an input and/or output interface formed, for example, by a display 706 and a keyboard 708. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 702, memory 704, and input and/or output interface such as display 706 and keyboard 708 can be interconnected, for example, via bus 710 as part of a data processing unit 712. Suitable interconnections, for example via bus 710, can also be provided to a network interface 714, such as a network card, which can be provided to interface with a computer network, and to a media interface 716, such as a diskette or CD-ROM drive, which can be provided to interface with media 718.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 718) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 704), magnetic tape, a removable computer diskette (for example, media 718), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 702 coupled directly or indirectly to memory elements 704 through a system bus 710. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 708, displays 706, pointing devices, and the like) can be coupled to the system either directly (such as via bus 710) or through intervening I/O controllers (omitted for clarity).

Network adapters such as network interface 714 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, segmenting a dataset using an iterative process involving a decision tree and learning where the dataset is automatically partitioned to identify certain claims that can be electronically settled.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for processing insurance claims on a fast track basis, the method comprising
receiving an insurance claim, the insurance claims being made by a user;
extracting from the insurance claim received a set of pre-defined parameters, wherein the pre-defined parameters are a set of influencing parameters defined by the insurance business;
computing a threshold value for each of the pre-defined influencing parameters, wherein the insurance business is configured to set a threshold value for each of the pre-defined influencing parameters, and the threshold are computed by iterating the identified pre-defined threshold values such that the pre-defined threshold values reach a constant value for the insurance claim;
routing the insurance claims to be processed on a fast track basis if the computer threshold value falls below a pre-defined value set by the insurance business.

2. The method of claim 1, wherein the threshold values may be provided by the user if prompted.

3. The method of claim 1, wherein the insurance claims and all the pre-defined influencing parameters identified are stored in a repository.

4. The method of claim 3, wherein a mapping is created between each insurance claims and the influencing parameters.

5. The method of claim 4, wherein the repository is dynamically updated.

6. The method of claims 3, wherein on receiving the insurance claims, the repository is configured to dynamically identify a set of influencing parameters and an associated threshold value for each of the influencing parameters.

7. The method of claim 6, wherein the influencing parameters and threshold values are used to iteratively computer a converged threshold value for each of the influencing parameters.

8. The method of claim 7, wherein the repository may store data in one of a structured or unstructured format.

9. The method of claim 7, wherein the influencing parameters are processing time and indemnity value of the insurance claims.

10. The method of claim 9, wherein computing the threshold values comprises
(a) setting a threshold value for time and determining and adjusting a threshold value for indemnity;
(b) setting a threshold value for indemnity and adjusting the threshold value for time; and
(c) repeating steps (a) and (b) until threshold values for time and indemnity remain constant.

11. A system for processing insurance claim, comprising:
a memory; and
at least one processor coupled to said memory and operative to:
receive an insurance claim, the insurance claims being made by a user;
extract from the insurance claim received a set of pre-defined parameters, wherein the pre-defined parameters are a set of influencing parameters defined by the insurance business;
compute a threshold value for each of the pre-defined influencing parameters, wherein the insurance business is configured to set a threshold value for each of the pre-defined influencing parameters, and the threshold are computed by iterating the identified pre-defined threshold values such that the pre-defined threshold values reach a constant value for the insurance claim;
route the insurance claims to be processed on a fast track basis if the computer threshold value falls below a pre-defined value set by the insurance business.

12. The system of claim 11, wherein the threshold values are time and indemnity.

13. The system of claim 11, wherein the insurance claims and all the pre-defined influencing parameters identified are stored in a repository.

14. The system of claim 13, wherein a mapping is created between each insurance claims and the influencing parameters.

15. The system of claim 14, wherein the repository is dynamically updated.

16. The system of claim 13, wherein on receiving the insurance claims, the repository is configured to dynamically identify a set of influencing parameters and an associated threshold value for each of the influencing parameters.

17. The system of claim 13, wherein the repository may store data in one of a structured or unstructured format.

18. The system of claim 11, wherein computing the threshold values comprises
(a) setting a threshold value for time and determining and adjusting a threshold value for indemnity;
(b) setting a threshold value for indemnity and adjusting the threshold value for time; and
(c) repeating steps (a) and (b) until threshold values for time and indemnity remain constant.
